(19) United States
(12) Patent Application Publication
(10) Pub. No.: US 2007/0014484 A1
(43) Pub. Date: Jan. 18, 2007

(54) Method and system for adaptive film grain noise processing

(76) Inventor: Alexander Maclnnis, Lake Oswego, OR (US)

Correspondence Address: MCANDREWS HELD & MALLOY, LTD, 500 WEST MADISON STREET, SUITE 3400, CHICAGO, IL, 60661, US

(21) Appl. No.: 11/485,685

(22) Filed: Jul. 13, 2006

Related U.S. Application Data
(60) Provisional application No. 60/701,178, filed on Jul. 18, 2005.
(60) Provisional application No. 60/701,179, filed on Jul. 18, 2005.
(60) Provisional application No. 60/701,181, filed on Jul. 18, 2005.
(60) Provisional application No. 60/701,180, filed on Jul. 18, 2005.
(60) Provisional application No. 60/701,177, filed on Jul. 18, 2005.
(60) Provisional application No. 60/701,182, filed on Jul. 18, 2005.

(51) Int. Cl. G06K 9/40

(52) U.S. Cl. 382/275; 382/261

(57) ABSTRACT

Described herein are a method and system for distinguishing various characteristics of an image and selectively removing them. In video processing applications, the available compression bandwidth may determine the amount of coding loss that will be required. For very low rate encoding, film grain noise may be removed in order to maintain picture quality. For higher rate encoding, the method and system may distinguish a analog noise level from a film grain noise level. According to the film grain noise level and the encoding rate, encoding may selectively remove analog noise and maintain film grain noise.

### RELATED APPLICATIONS

This application claims priority to METHOD AND SYSTEM FOR ADAPTIVE FILM GRAIN NOISE PROCESSING, Provisional Application for U.S. patent Ser. No. 60/701,178, filed Jul. 18, 2005, by MacInnis, which is incorporated by reference herein for all purposes.

This application is related to the following applications, each of which is hereby incorporated herein by reference in its entirety for all purposes:

U.S. Provisional Patent Application Ser. No. 60/701,179, METHOD AND SYSTEM FOR NOISE REDUCTION WITH A MOTION COMPENSATED TEMPORAL FILTER, Attorney Docket No. 16839US01, filed Jul. 18, 2005 by Alexander MacInnis;

U.S. Provisional Patent Application Ser. No. 60/701,181, METHOD AND SYSTEM FOR MOTION COMPENSATION, filed Jul. 18, 2005 by MacInnis;

U.S. Provisional Patent Application Ser. No. 60/701,180, METHOD AND SYSTEM FOR VIDEO EVALUATION IN THE PRESENCE OF CROSS-CHROMA INTERFERENCE, filed Jul. 18, 2005 by MacInnis;

U.S. Provisional Patent Application Ser. No. 60/701,177, METHOD AND SYSTEM FOR ESTIMATING NOISE IN VIDEO DATA, filed Jul. 18, 2005 by MacInnis; and

U.S. Provisional Patent Application Ser. No. 60/701,182, METHOD AND SYSTEM FOR MOTION ESTIMATION, filed Jul. 18, 2005 by MacInnis.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

In video capturing applications, the contribution of signal and noise varies with the nature of the capture medium, i.e. film vs. videotape or solid state, but with most technology, a contribution of film grain noise may appear with a captured image. Film grain noise may look desirable under the right circumstances when the filmmaker is attempting to convey a certain “feel” to a scene. For example, the grain characteristics may help to transport the viewer to the time and environment in which the film is set, or a heavy grain may be used to create a haze that helps support the suspense of the film on a subconscious level.

Film grain noise may be an element that is crucial to preserving the original intent of filmmakers. However when predictive coding techniques are used to store and/or transmit video, film grain noise may not be distinguishable from analog noise. Analog noise is not typically crucial to preserving the original intent of filmmakers. Film grain noise could be attenuated by digitization at the same time as analog noise. Lossy encoders may tend to suppress film grain noise when filtering the high frequencies typically associated with noise and fine textures. Visually lossless encoding is achieved only at very high bit rates. Lossy encoders could produce clean digital video without the texture intended in the original film and may alter the original creative intent of moviemaker.

The preservation of film grain may be a feature in high-definition encoders. Video techniques currently exist for film grain emulation to provide a consistent look to a video sequence when merging computer-generated images with film material. Such effort to filter and restore film grain may demand large amounts of processing and storage bandwidth.

Limitations and disadvantages of conventional and traditional approaches will become apparent to one of ordinary skill in the art through comparison of such systems with the present invention as set forth in the remainder of the present application with reference to the drawings.

### BRIEF SUMMARY OF THE INVENTION

Described herein are system(s) and method(s) for estimation and adaptive removal of film grain noise in a video sequence, substantially as shown in and/or described in connection with at least one of the figures, as set forth more completely in the claims.

These and other advantages and novel features of the present invention will be more fully understood from the following description.

### BRIEF DESCRIPTION OF THE DRAWINGS

FIG. 1 is a block diagram of an exemplary system for film grain noise estimation in accordance with an embodiment of the present invention;

FIG. 2 is a block diagram of an exemplary system for film grain noise processing in accordance with an embodiment of the present invention;

FIG. 3 is a flow diagram of an exemplary method for adaptive film grain noise processing in accordance with an embodiment of the present invention; and

FIG. 4 is a picture of an exemplary video display device in accordance with an embodiment of the present invention.

### DETAILED DESCRIPTION OF THE INVENTION

Described herein are methods and systems for distinguishing various characteristics of an image and selectively reducing or removing them. In video processing applications, the available bandwidth may determine the amount of coding loss that will be required. For very low rate encoding, film grain noise may be removed in order to maintain picture quality. For higher rate encoding, an analog noise level may be distinguished from a film grain noise level. According to the film grain noise level and the encoding rate, encoding may reduce analog noise and selectively maintain film grain noise.

The fields forming a video frame may comprise a plurality of ordered lines. For interlaced video, content for the top field may be captured during one time interval while content for the bottom field may be captured during another time interval.

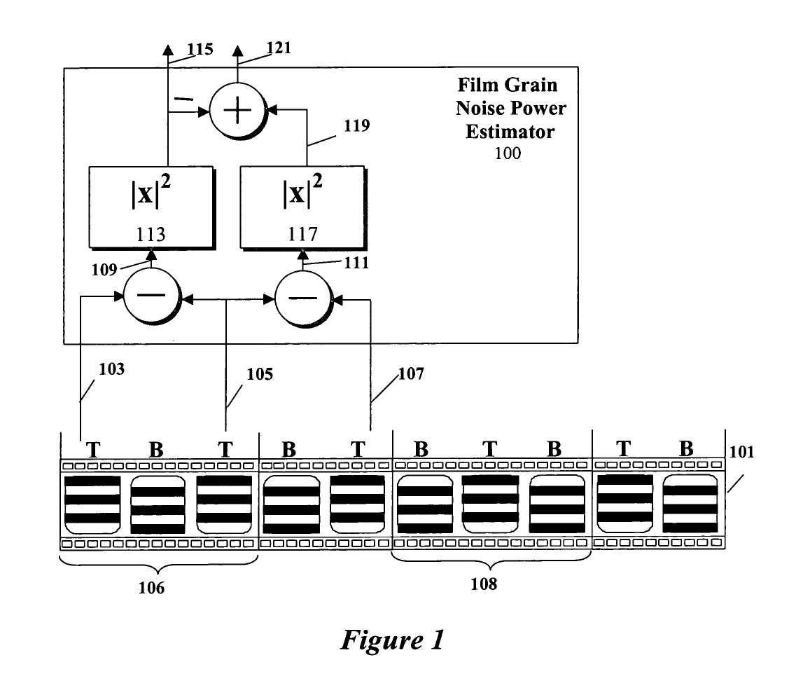

FIG. 1 is a block diagram of an exemplary system 100 for film grain noise estimation in accordance with an embodiment of the present invention. In a 3:2 pulldown pattern of an interlaced sequence 101, the first field 103 and the third field 105 of the TBT frames are theoretically identical, the difference 109 may be analog noise. Other pairs of like-polarity fields such as 105 and 107 may have some inter-field differences. When the like-polarity fields 105 and 107 represent a static image, the differences 111 may be due to analog noise as well as film grain noise.

Analog noise power 115 may be estimated by computing the squared magnitude 113 of the residual difference 109 between the top fields 103 and 105 in a TBT frame 106. Likewise, analog noise power may be estimated by computing the squared magnitude of the residual difference between the bottom fields in a BTB frame 108. Like-fields in the same frame comprise desired content that is the same (i.e. correlated) and undesired analog noise that is different (i.e. uncorrelated).

The sum 119 of the film grain noise power and the analog noise power may be estimated from a static pixel window. The squared magnitude 117 of the residual difference 111 between a field 105 in one frame and a like-polarity field 107 in another frame would be the noise power estimate 119 of the sum of the film grain noise power and the analog noise power. The difference between 119 and 115 may represent the film grain noise power estimate 121.

A “window” is an array of sample locations used for measurement purposes. Determining that the like-polarity fields 105 and 107 represent a static image may be accomplished on a window-by-window basis. The residuals 111 in a window may be compared to a maximum residual level that may be a function of an expected noise level. If any of the residuals 111 in the window are greater than the maximum residual level, the window of residual may be considered to contain differences in image content and hence discarded, and a new window of residuals may be tested.

A system that may determine the lack of motion in a video sequence prior to estimating noise can be found in the system(s), method(s), or apparatus described in METHOD AND SYSTEM FOR ESTIMATING NOISE IN VIDEO DATA, Attorney Docket No. 16843US01, filed Jul. 18, 2005 by MacInnis, which is incorporated herein by reference for all purposes.

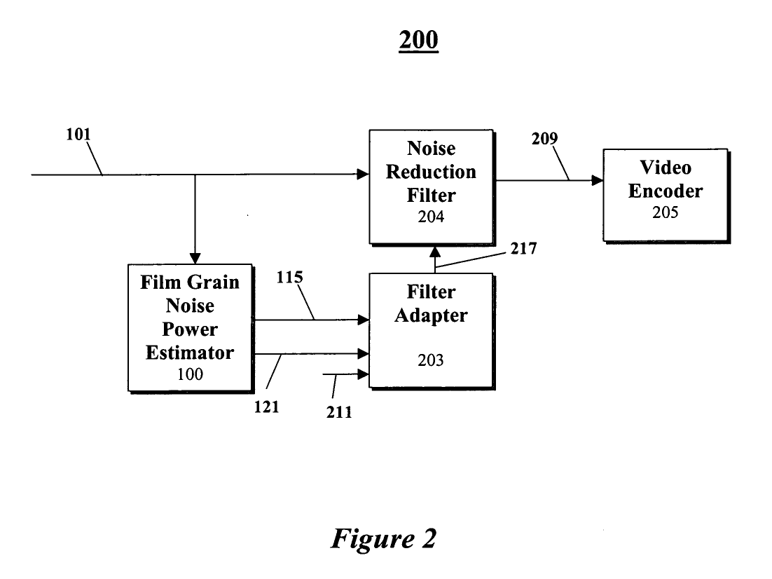

FIG. 2 is a block diagram of an exemplary system 200 for film grain noise processing in accordance with an embodiment of the present invention. The film grain noise processing system 200 comprises a video encoder 205, a noise reduction filter 204, a filter adapter 203, and the film grain noise power estimator 100 as described in reference to FIG. 1.

Video encoder 205 may comprise suitable logic, circuitry and/or code that may be adapted to perform fixed or variable rate video encoding. Such video encoding may comprise spatial prediction and motion estimation. The motion estimation may utilize a noise level to improve performance.

Motion estimation that improves performance by utilizing a noise level estimate can be found in system(s), method(s), or apparatus described in METHOD AND SYSTEM FOR MOTION ESTIMATION, Attorney Docket No. 16844US01, filed Jul. 18, 2005 by MacInnis, which is incorporated herein by reference for all purposes.

The filter adapter 203 may comprise suitable logic, circuitry and/or code that may adapt the degree of filtering 217 in the noise reduction filter 204 based on a degree of video compression 211, the analog noise estimate 115 and the film grain noise estimate 121.

The noise reduction filter 204 filters the video sequence 101 and the video encoder 205 processes the filtered video sequence 209. With a high degree of compression, the encoding may be lossy. The bandwidth of the video encoder 205 may be utilized to optimize video quality, and high frequency artifacts, such as film grain noise, that require more data may be removed. With a low degree of compression, the encoding may maintain high frequency artifacts, such as film grain noise.

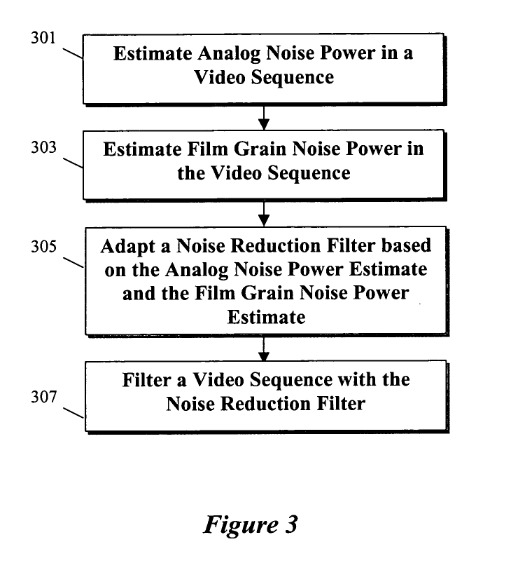

FIG. 3 is a flow diagram of an exemplary method for adaptive film grain noise processing in accordance with an embodiment of the present invention.

At 301, analog noise power in a video sequence is estimated. The video sequence may comprise frames with interlaced fields. An example pattern for interlaced fields is 3:2 pulldown. The interlaced fields have two polarities—a top field (T) and a bottom field (B). In the 3:2 pulldown, a pattern with four types of frames is used. In a first frame type, the fields are TBT where the two top fields contain the same video content and may contain uncorrelated analog noise. In a second frame type, the fields are BT. In a third frame type, the fields are BTB where the two bottom fields contain the same video content and may contain uncorrelated analog noise. In a fourth frame type, the fields are TB. Analog noise power may be estimated based on the difference between the two like-fields in the same frame, i.e. the first or third frame type.

At 303, film grain noise power in the video sequence is estimated. The sum of the analog noise and film grain noise may be estimated based on windows in different frames that comprise static video. An estimate of the film grain noise can be the difference between this sum and the analog noise estimate found in step 301.

At 305, a noise reduction filter is adapted based on the analog noise power estimate and the film grain noise power estimate. And at 307, the video sequence is filtered by the noise Reduction filter.

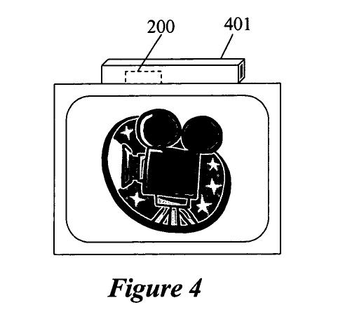

FIG. 4 is a picture of an exemplary video display device 401 containing a system for film grain noise processing 200 in accordance with an embodiment of the present invention. This video encoding system may be a set top box that receives noisy analog video. The system for film grain noise processing 200 may adaptively remove or maintain film grain noise during the encoding of communicated video data according to the data rate and the film grain noise power level.

The embodiments described herein may be implemented as a board level product, as a single chip, application specific integrated circuit (ASIC), or with varying levels of a video processing circuit integrated with other portions of the system as separate components. An integrated circuit may store video data in memory and use an arithmetic logic circuit to perform noise estimation and video coding.

The degree of integration of the estimation and coding circuitry will primarily be determined by the speed and cost considerations. Because of the sophisticated nature of modern processors, it is possible to utilize a commercially available processor, which may be implemented external to an ASIC implementation.

If the processor is available as an ASIC core or logic block, then the commercially available processor may be implemented as part of an ASIC device wherein certain functions may be implemented in firmware as instructions stored in a memory. Alternatively, the functions may be implemented as hardware accelerator units controlled by the processor.

While the present invention has been described with reference to certain embodiments, it will be understood by those skilled in the art that various changes may be made and equivalents may be substituted without departing from the scope of the present invention.

Additionally, many modifications may be made to adapt a particular situation or material to the teachings of the present invention without departing from its scope. For example, the invention may be applied to video data associated with a wide variety of analog and/or digital standards in addition to NTSC.

Therefore, it is intended that the present invention not be limited to the particular embodiment disclosed, but that the present invention will include all embodiments falling within the scope of the appended claims.

1. A method for film grain noise processing, said method comprising:
estimating analog noise power in a video sequence;
estimating film grain noise power in the video sequence;
adapting a filter based in part on the analog noise power estimate and film grain noise power estimate; and
filtering the video sequence with said filter.

2. The method of claim 1, wherein the video sequence comprises interlaced fields.

3. The method of claim 2, wherein the video sequence comprises frames, and wherein every second frame comprises two fields with correlated content and uncorrelated noise.

4. The method of claim 3, wherein analog noise power is estimated based on the difference between the two fields with correlated content and uncorrelated noise.

5. The method of claim 1, wherein the combination of film grain noise power and analog noise power is estimated based on the differences between fields in different frames.

6. The method of claim 5, wherein the combination of film grain noise power and analog noise power is estimated when a window, of the fields in the different frames, is classified as static.

7. The method of claim 1, wherein the amount of filtering is based on a degree of video compression.

8. A system for film grain noise processing, said system comprising:
a noise reduction filter;
a first circuit for estimating analog noise power and film grain noise power in a video sequence; and
a second circuit for adapting the noise reduction filter based on the analog noise power estimate and film grain noise power estimate.

9. The system of claim 8, wherein the video sequence comprises interlaced fields.

10. The system of claim 9, wherein the video sequence comprises frames, and wherein every second frame comprises two fields with correlated content and uncorrelated noise.

11. The system of claim 10, wherein the first circuit estimates analog noise power based on the difference between the two fields with correlated content and uncorrelated noise.

12. The system of claim 8, wherein the first circuit estimates film grain noise power based on the differences between fields in different frames.

13. The system of claim 12, wherein the first circuit estimates film grain noise power when a window, of the fields in the different frames, is classified as static.

14. The system of claim 8, wherein the second circuit changes the amount of filtering based on a degree of video compression.

15. A video display device comprising:
an integrated circuit comprising:
a memory for storing a video sequence; and
a circuit operable for:
estimating analog noise power in the video sequence;
estimating film grain noise power in the video sequence; and
adapting a noise reduction filter based on the analog noise power estimate and film grain noise power estimate.
